(19) United States
(12) Patent Application Publication
(10) Pub. No.: US 2020/0058135 A1
(43) Pub. Date: Feb. 20, 2020

(54) SYSTEM AND METHOD OF OBJECT POSITIONING IN SPACE FOR VIRTUAL REALITY

(71) Applicant: Difference Engie, Inc., New York, NY (US)

(72) Inventors: ROMAN MIKHAILOV, Tula (RU); ISKANDER KHABIBRAKHMANOV, Kazan (RU)

(21) Appl. No.: 16/086,113

(22) PCT Filed: Oct. 12, 2016
(86) PCT No.: PCT/RU2016/000695

§ 371 Date: Sep. 18, 2018

(51) Int. Cl. G06T 7/73; G06K 9/40; G06T 7/00; G06K 9/00

(52) U.S. Cl. CPC G06T 7/73; G06K 9/40; G06T 2207/30204; G06K 9/00624; G06T 2207/30168; G06T 7/0002

(57) ABSTRACT

Disclosed is a method, a device, a system and/or a manufacture of object positioning in space for virtual reality. For example, in one embodiment real-time positioning of a person in a hybrid physical and virtual environment is achieved through recognition of graphical markers placed in the physical environment and stored in a recognition library. The method includes capturing a marker with a gyroscopically stabilized camera, normalizing and filtering the image, search and identification of the recognized markers, evaluation of a quality of each recognized marker, selection of a best marker based a quality metric, calculation of a set of physical coordinates of the camera based on the best marker, filtration of the set of physical coordinates, and sending the set of filtered coordinates of the camera through a transceiver to one or more computing devices.

### CLAIM OF PRIORITY

This application is a U.S. National Phase Application, under 35 U.S.C. § 371, of PCT International Application No. PCT/RU2016/000695, with an international filing date of Oct. 12, 2016, which is hereby incorporated by reference for all purposes.

### FIELD OF TECHNOLOGY

This invention relates to real-time positioning of an object that is mobile in a physical space on the whole and, specifically, to positioning of a human in a mixed reality.

The invention is a hardware-software complex designed to solve the problem of continuous positioning (position location) of an object in space.

Possible applications of the system include but are not limited to such fields as real-time positioning of drones and industrial robots, humans and other objects in mixed reality.

### BACKGROUND

Current popularity of mixed reality systems necessitated development of a fast and efficient solution to position a human in space of any dimension. Today the market offers several types of such systems.

However, most solutions were primarily not developed to operate in the mixed reality. The existing systems positioning a mobile object fall into two types.

A first type of positioning system is “Outside-in.” Initially such systems were used to create animation in computer games and in the cinema. The active part of the hardware-software complex is in a space within which the object moves. An example is the solution of the “Optitrack” company, in which cameras are fixed along the perimeter of a space, reflectors are fixed on the moving object, and the cameras locate position of the reflectors in the space. Such solutions are traditionally costly because they require numerous active elements (e.g., cameras) and may be difficult to configure. In such solutions all objects to be positioned may have to be in the viewing box; this produces the problem of positioning several objects when they overlap.

A second type of positioning is “Inside-out,” based on visual markers. When the active part of the hardware-software complex is on the mobile object and markers are in the space. These solutions may be designed to position robots and drones. Most inside-out solutions are based on the use of a camera and a set of graphic markers with coordinates known beforehand. The camera captures the image with markers and applies geometry transformations determine a position of the camera in space.

The prior art discloses different systems positioning a dynamic object in space in real time. An example of such a system is the system correcting the drift of micromechanical gyroscope used in the system of augmented reality on a moving object (see, e.g., patent of the Russian Federation, RU 2527132 C1, cl. G01C 21/18). The prior system describes a built-in micromechanical gyroscope and a miniature video camera in augmented reality goggles; the system, at this, contains markers which are always in a viewing box of a video camera irrespective of a position the object.

The prior art also discloses a system displaying virtual reality (see US patent application, US 2004/0001647 A1, cl. G06K 9/36). The known system contains markers fixed on the ceiling and a camera in a vertical position aimed to the ceiling. The camera captures the image containing the markers on the ceiling, transmits the image to the marker recognition device after which a 3-D virtual reality is imaged.

The prior art discloses an augmented reality system using invisible markers (see, e.g., US patent application, US 2014/0232749 A1, cl. G06T 19/00). The known system contains markers and a camera that recognizes these markers. Then the recognized markers are transmitted to an image processing system which, in its turn on the basis of recognized markers yields a virtual reality image.

However, the prior art solutions may have several disadvantages which may include insufficient accuracy and visual noise in recognition of the graphic markers, and eventually may result in motion sickness of the user due to inaccurate representation of visualized information the user develops controversy between the visually perceived information and the vestibular apparatus. Further, because of numerous oscillating movements, camera bouncing caused by object movements, loss of markers from the viewing volume when the body changes position (e.g., bending, squatting, etc.) systems may develop additional noise affecting the accuracy of graphic marker recognition.

Thus, there is a continuing need for increasing the accuracy of recognition of graphic markers. Further, the prior art solutions using visual markers may be good for known graphic markers with saved coordinates but may be incapable of supplementing the marker base with new graphic markers with calculated coordinates, eventually the entire system may have to be reconfigured on the whole and the accuracy of defining the graphic markers may be affected.

### SUMMARY

Various embodiments of the hardware-software complex solve one or more of the aforesaid problems.

A gyroscopic stabilizer helps eliminate bouncing of a camera and provides for a continued visibility of one or more markers with a minimum number of surfaces on which the markers are paced without limiting human actions. Stable operation is attained even when the markers are only placed on a single instance of a surface.

A software part of the invention allows the presented hardware-software complex to learn and to obviate the need to reconfigure the system when expanding the number of markers used in the physical space, as a consequence this increases the accuracy of visually recognizing the markers.

In a first embodiment, a computerized method of positions an object that is mobile with a camera in physical space for virtual reality in real time, wherein the camera is fixed on a mobile object by a two-axis or three-axes gyroscopic stabilizer and is capable of capturing an image and recognizing the graphic markers in the image, the method, comprises the following processes: (i) a process of capturing the image having one or more graphic markers on at least one plane by means of the camera fixed on the object; (ii) a process of recognition by means of the camera fixed on the object of the one or more graphic markers contained in the image performed by means of a recognition library of graphic markers, the stage of recognizing one or more graphic markers comprising a normalization of the image, a filtration of the image, a search of the one or more graphic markers, an identification of the one or more recognize markers, and an isolation of one or more of the one or more recognized markers; (iii) a process of reading the one or more recognized markers by means of a computational-communication module; (iv) a process of evaluating a quality of each graphic marker in the one or more recognized markers by means of the computational-communication module; (v) a process of selecting by means of the computational-communication module a best marker based on the process of evaluating the quality, but if before not all the one or more recognized markers have been evaluated for quality, returning to the process of reading one or more recognized markers; (vi) a process of calculating a set of physical coordinates of the camera by means of the best selected graphic marker; (vii) a process of filtering the set of physical coordinates of the camera by means of a Kalman filter capable of a self-tuning; and (viii) a process of transmitting the a set of filtered coordinates of the camera to one or more external computing devices.

A second embodiment provides for the system of positioning the object that is mobile with a camera in space for virtual reality in real time, the camera fixed on a mobile object by a gyroscopic stabilizer having two axes or three axes and capable of capturing the image and recognizing the graphic markers, the system comprising, connected with the camera by a wireless or a wireline communication a computational-communication module with an integrated memory storing the marker base, the memory comprising machine-readable instructions effecting the computational-communication module to: (i) capture the image with one or more graphic markers on at least one plane by means of the camera fixed on the object on; (ii) recognize one or more of the graphic markers by means of the camera fixed on the object performed by a recognition library of graphic markers, the recognition of one or more recognized markers comprising a normalization of the image, a filtration of the image, a search of the one or more recognized markers, an identification of one or more recognized markers, and isolation of one or more of the one or more recognized markers; (iii) reading of the one or more recognized markers; (iv) evaluate a quality of each of the one or more recognized markers; (v) select on the basis the quality evaluation a best marker, but if not all of the one or more recognized markers have been processed a return to the reading the one or more recognized markers is performed; (vi) calculate a set of physical coordinates of the camera by means of the best marker; (vii) filter the set of physical coordinates of the camera by means of a Kalman filter capable of self-tuning; and (viii) save and send a set of filtered coordinates of the camera to one or more external devices by means of a transceiver.

In a third embodiment, a machine-readable medium stores instructions that when executed by the computer effect the camera fixed on the object that is mobile by means of the gyroscopic stabilizer having two axes or three axes and the computational-communication module with an integrated memory to carry out stages of the method of positioning an object that is mobile with a camera in the space for virtual reality in real time.

It will be apparent that, both the previous general disclosure and the following detailed disclosure are given as examples and are not a limitation of the claims.

### BRIEF DESCRIPTION OF THE DRAWINGS

FIG. 1 shows an example of a set of operations for the method of positioning an object that is mobile with a camera in a space for virtual reality in real time.

FIG. 2 shows an example of implementing the system of positioning the object with the camera in space for virtual reality in real time.

FIG. 3 shows an example of expanding an efficient zone of a physical environment of the object with a camera having a gyroscopic stabilizer fixed on the camera.

FIG. 4 illustrates an example of implementing a computational-communication module carrying out processing, storing, and sending the data in accordance with subject invention.

### DETAILED DESCRIPTION

For a better understanding by a specialist in this field of technology, below are terms used to describe this invention.

“Mixed reality”, sometimes called “MR” or “hybrid reality”, is a combination of real and virtual world to create new environments and visualizations where the physical and digital world coexist and interact in real time, existing, at that, not only in real or virtual form, but also as a mixture of physical and virtual reality.

A “Premises” is a physical location relative to which an object is positioned. The premises can be a room or a different part of space where the markers are installed.

A “Graphic marker” is a graphic image such as of rectangular form which can be recognized by the camera. The current version of the software-hardware complex uses but is not limited to the markers of rectangular form using a Hamming code. Such a marker is a black-and-white image with a bit coding (e.g., a white color—one, a black color—zero).

“Marker base” is a database specifying one or more markers of a set of total markers which can be used to configure the premises. Not all these markers of the set of total markers need to be used in the premises, however.

A “Servo drive” is a drive controlled by an inverse feedback making it possible to accurately control motion parameters.

At the beginning of setup with the premises the following settings are input into the system: one or more graphic markers each with an identification number, where a graphic marker for example is a black-and-white square image divided into squares. Each of the one or more markers is configured by a mask of zeroes and ones. E.g., 000/010/000 represents a 3-by-3 instance of the graphic marker with a central cell colored white. The space coordinates are specified for one or more markers of the set of total markers.

Below with a reference to the accompanying drawings is provided a detailed description designed to further explain the above elements, technical solutions, and advantages of the invention.

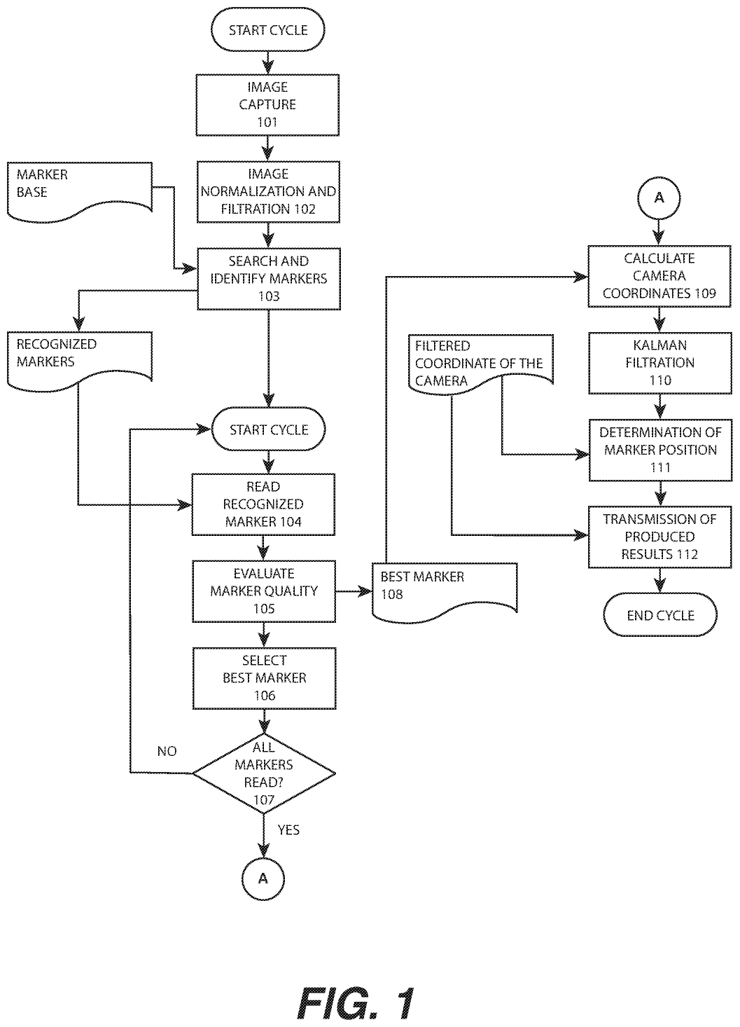

FIG. 1 shows an example of a sequence of operations for the method of positioning with a camera in space for virtual reality in real time. The method comprises the following operations:

Operation 101: By means of the camera the image is captured in real time. The image produced is stored in a computer memory supporting, but not limited to, jpeg, bmp or png formats.

Operation 102: The saved image is normalized by means such as ARToolkit library, the normalization comprises, optimization of the resolution, and contrast and color balance to improve recognition of the markers. This procedure can be performed by means of other external libraries, such as ARTag, ARUco, OpenCV and VisionWorks, but is not limited to them.

Operation 103: After normalization of the image the markers in the image are identified by means such as ARToolkit library. For each identified marker a rotation of the marker, a set of coordinates of its vertices and an identification number of the marker are stored in the marker base. In the event when coordinates one or more markers are unknown and are new, during the below described stage 111 a set of coordinates of one or more new markers are calculated.

Operation 104: In addition to the one or more markers identified at cycle 103, and for which physical coordinates are known, a subset of the one or more markers (e.g., one or more recognized markers) is chosen, the subset later used to calculate the coordinate of the camera.

Operation 105: A quality of the subset of one or more recognized markers is evaluated by an area of each marker of the one or more recognized markers in the image, is the area calculated by means of coordinates of the marker vertices. In addition to the area, account is taken of a confidence coefficient, obtained by means such as ARToolkit library, account is taken of the fact whether an instance of the marker was used in a previous cycle, a marker illuminance level, and a marker location and/or arrangement in the image (e.g., near a center of the image). Account of the marker location improves the quality of marker selection, because a part of the images located in the periphery of the image (at the edge or on the image edge) are distortion-prone because of specifics of optics of the camera. The confidence coefficient is understood to be a numerical value of probability that an instance of the marker is actually an instance of the marker recognized by the system. Quality evaluation can vary, giving preference to one quality metric or another, or adding new quality metrics. If the room configuration uses several planes and several types of markers, to evaluate the quality this method can use a priority parameter, e.g., “A square marker on the ceiling is more important than a round marker on the wall”. This particular case is only an example of implementation for a specialist in this field of technology to have a better understanding, and is not designed to limit the claims.

Operation 106: An instance of the marker with a higher quality by a sum of one or more criteria from step 105 is chosen as a best marker.

Operation 107: A check is carried out to identify whether all of the one or more markers have undergone a quality evaluation, and in the event that not all of the one or more recognized markers have been evaluated, executes a return to stage 105.

Operation 108: The graphic marker evaluated at step 107 as the best marker is further used to determine a position the camera in the physical space.

Operation 109: In this process a set of physical coordinates of the camera are calculated. For the best marker (108) an inverse transformation of space is defined, this transfers a point from a first set of coordinates in a marker coordinate basis into a second set of coordinates in a camera coordinate basis, in the form T=(R, A), where R is a rotation matrix, and A (x, y, z) is a transfer vector. Further on, the application of this transformation to vector coordinates in a room produces a set of coordinates of a true position of the camera in the physical space.

Operation 110: The produced coordinates together with an acceleration data received from a gyroscopic stabilizer pass through a Kalman filter to eliminate noise. The current example of tuning the Kalman filter includes but is not limited to such variables as the set of physical coordinates, a speed of the object, and an acceleration of the object. The Kalman filter is capable of a self-tuning, i.e., it is the Kalman filter receiving data on object motion from different sources that forms a probabilistic model for the further measurement of values. The more numerous are the data the more accurate is the probabilistic model. A check is also carried out whether the best marker was used in a previous cycle. This check also helps improve formation of the probabilistic model. The filter is refined (set) with each cycle.

Operation 111: After the filtered data are received from the Kalman filter a filtered coordinate is calculated. One or more of the markers from the marker base may not have a physical coordinate associated, because at the time of system configuration such markers were not used in the room (e.g., saved to further expand the room). If such markers were recognized in the image, for each of them a position in physical space relative to the camera is defined (with defined position in space) and stored in the marker base.

To assist in understanding the calculation of the coordinates of one or more new associated markers, consider the following example omitted in the drawings.

Fixed on a plane are, e.g., 50 markers in a line, but associated with a set of physical coordinates is the position of a first marker only. The camera captures the marker 1 and a marker 2, and defines a physical coordinate of marker 2 by the known set of physical coordinates of the marker 1 and geometry transformations of the data received from the gyroscopic stabilizer (e.g., speed, acceleration, etc.), and saves the set of physical coordinates of a new marker in the marker base to define a new associated marker. After the mobile objects moves farther, the camera captures the marker 2 and a marker 3. By analogy of defining the set of physical coordinates of marker 2 the physical coordinates of the marker 3 are defined. This provides for the possibility to move and recognize the position of an object that is mobile while initially saving in the system physical coordinates of only the marker 1. Owing to this autonomous determination of coordinates of the new associated marker, reconfiguration of the entire system is not needed. These examples are only one of the versions of embodiment of this invention and is not designed to limit the scope of the claims.

Operation 112: The data on position of the camera are transmitted by a communication module through a network, by wireless or by other methods to a receiver module which may later use the data on position of the object in physical space.

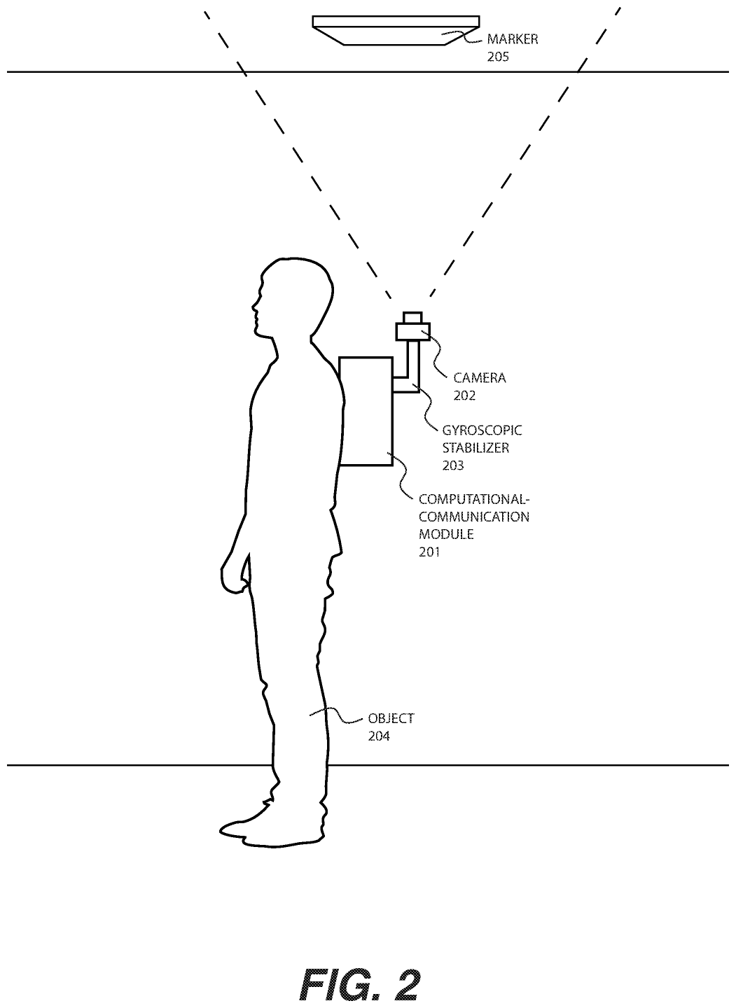

FIG. 2 shows an example of hardware implementation of the positioning system with a camera in space for virtual reality in real time.

The computational-communication module (201) which is a computer with integrated transceiving device (e.g., a communication module) and a memory storing software. The computer is connected to the gyroscopic stabilizer (203), which is connected in turn to the camera (202). The computational-communication module is fixed on the mobile object (204) for which the position in physical space is to be determined.

The camera (202) fixed on the gyroscopic stabilizer (203) captures the image and transmits the image to the computational-communication module (201). The camera can operate both in the visible and infrared ranges. The camera can be a standard digital camera operating in the visible range at the rate of 60 frames per second. To operate in the infrared range a camera is used which operates in a wavelength range of 700-1400 nm at the speed of 60 or more frames per second.

The gyroscopic stabilizer (203) ensures a required tilt of the camera and stabilizes the image with objection motion. The system can use either 2-axis or 3-axis gyroscopic stabilizer, consisting, respectively, of 2 or 3 chips with accelerometer, gyroscope, and servo drives. The operation of the system is not limited to the specific design of the stabilizer and is compatible with any hardware implementation making possible to hold the preset position of the object. The gyroscopic stabilizer makes possible to produce necessary parameters, such as data on acceleration and tilt, and transmits these data to the computational-communication module.

The object (204) that is mobile, which can be, but is not limited to a drone and a robot for which position in space is determined.

The graphic markers (205), are fixed on, at least, one plane. In this case, the plane can be either horizontal or vertical. The horizontal plane is can be understood to be the ceiling of a room, and the vertical plane at least, one of the walls of the room.

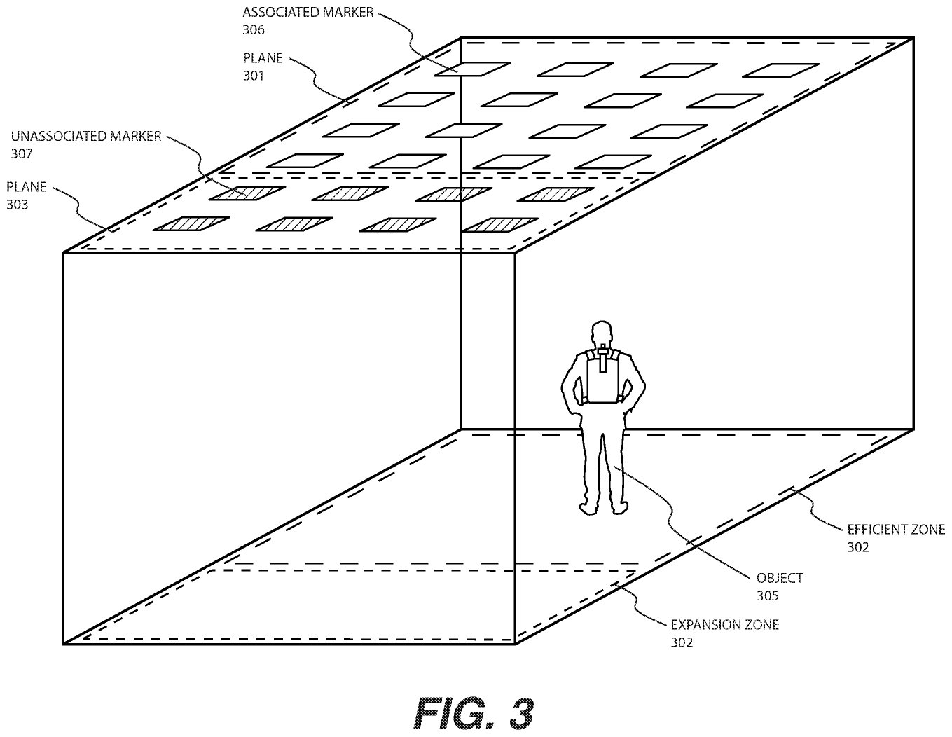

FIG. 3 shows an example of expanding an efficient zone of motion of the object with the camera and the gyroscopic stabilizer fixed on it, the expansion, carried out to expand the efficient zone into an expansion zone.

The efficient zone (302) of motion of the object is understood to mean a zone in which the object with the gyroscopic stabilizer and the camera (305) can move, a zone against the plane (301) with associated markers or a perpendicular plane (not shown) to the plane (301), with a set of markers (306) whose coordinates are known and saved in the marker base. The expansion space (304) is understood to mean a zone in which the object can move only when the physical coordinates of one or more unassociated markers (307) are calculated and saved in the marker base, the expansion zone (304) against the plane (303) on which the unassociated markers (307) are located. After the coordinates of one or more unassociated markers (307) are calculated and saved in the marker base the expansion zone (304) becomes part of the efficient zone (302) of motion.

At the moment when the object (305) reaches the boundary of the efficient zone (302) and expansion zone (304), the camera detects one or more of the unassociated markers (307), lying on the plane (303) with the unassociated markers (307). When one or more of the unassociated markers (307) are recognized in the image, for each unassociated marker (307) position in space relative to the camera with already determined physical coordinates will be determined and saved in the marker base. As a common plane (the plane formed by the plane (301) and the plane 303) carries both the unassociated markers (307) and associated markers (306) to accurately determine the physical coordinates of the new markers suffice for the system to make a required number of measurements. Thus, the system expands the efficient zone (302) that is accessable for new motion without the need to change the settings. This example is only one of the embodiments of this invention and is not designed to limit the scope of the claims.

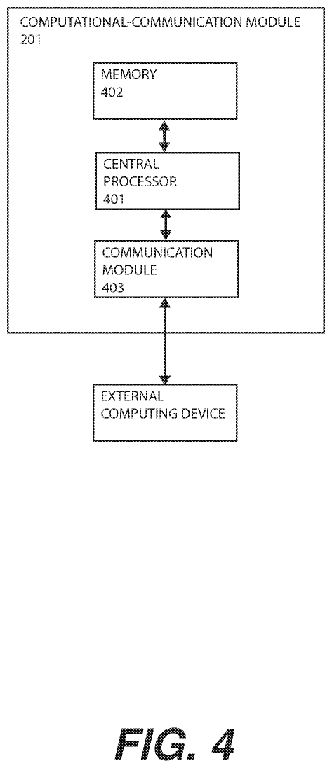

FIG. 4 shows an example of embodiment of the computational-communication module, for processing, saving and transmitting the data.

The computational-communication module comprises a central processor (CP 401), an integrated memory (402) connected with the central processor and a communication module (CM 403) also connected with the central processor.

CP 401 can be made, e.g., in the form of digital signal processor (DSP), one or several processor cores, a dual-core processor, a multi-core processor, a microprocessor, a processor host, a chip, a microchip, an integrated microcircuit (IM), an application specific integrated circuit (ASIC), or any other multipurpose or specific processor or controller. CP 401 executes commands of e.g., an operating system (OS) and/or the communication module 403 and/or one or several software applications.

Memory 402 can be made in the form of e.g. a hard disc, a solid-state drive, a flash memory, or other suitable removable or non-removable unit of storage. Memory 402, e.g., can store data processed by the communication module (CM 403) and/or central processor (CP 401).

The communication module (CM 403) can be made in the form of e.g., an aerial employing wireless communication interface or in the form of a switchboard employing a wireline communication interface. CM 403 provides for both reception and transmission of the data between the computational-communication module and one or more external computing devices capable of receiving/transmitting by means of wireline or wireless communication interfaces.

Although this invention has been shown and described with reference to certain embodiments, one skilled in the art will understand that different changes and modification can be made without leaving the actual scope of this invention.

1-20. (canceled)

21. A method for real-time positioning of an object in a physical environment and a virtual environment, the method comprising:
capturing with a camera attached to the object an image comprising one or more markers each having a graphic identifier;
at least one of normalizing and filtering the image to increase a recognition capability;
searching a marker base stored in a database;
recognizing the one or more markers within the marker base to result in one or more recognized markers;
evaluating a quality metric of each of the one or more recognized markers;
selecting based on the quality metric one or more best markers that are a subset of the one or more recognized markers;
calculating a physical coordinate of the object based on the one or more best markers;
filtering the physical coordinate of the object through a Kalman filter capable of self-tuning to result in a filtered physical coordinate; and
transmitting the filtered physical coordinate of the object to a computing device.

22. The method of claim 21, wherein the one or more recognized markers within the marker base are each associated with a coordinate data specifying a physical coordinate of each of the one or more recognized markers.

23. The method of claim 22, further comprising:
determining that one of the one or more recognized markers is unassociated with an instance of the physical coordinate within the marker base to determine an unassociated marker;
calculating a physical coordinate of the unassociated marker and generating a coordinate data of the unassociated marker; and
expanding the virtual environment by storing the physical coordinate of the unassociated marker in association with the unassociated marker in the marker base to result in a new associated marker.

24. The method of claim 23,
wherein one or more instances of the marker are attached to a planar surface, and
wherein the physical coordinate of the unassociated marker is determined based on one or more associated markers within view of the camera.

25. The method of claim 24, wherein the quality metric is at least one of: (i) a largest area of a marker within the image, (ii) a high confidence coefficient obtained through a marker recognition library, (iii) a high illuminance, and (iv) a best arrangement in the image.

26. The method of claim 25,
wherein the camera is installed on the object with a gyroscopic stabilizer vertically, the gyroscopic stabilizer stabilizing along at least two axes, to capture a horizontal plane to which the one or more markers are associated, and
wherein the horizontal plane is a ceiling of a room.

27. The method of claim 25,
wherein the camera is installed on the object with a gyroscopic stabilizer horizontally, the gyroscopic stabilizer stabilizing along at least two axes, to capture a horizontal plane to which the one or more markers are associated, and
wherein the vertical plane is a wall of a room.

28. The method of claim 26, wherein the object is at least one of a human, a drone, and a robot.

29. The method of claim 28, further comprising:
at least one of superimposing a black-and-white filter on the image, adapting a resolution of the image, and adapting a contrast of the image.

30. The method of claim 29, wherein recognition occurs through a recognition library that is at least one of: ArToolKit, ARTag, ARUco, OpenCV, and VisionWorks.

31. A system for real-time positioning of an object in a physical environment and a virtual environment, the method comprising:
an object capable of mobility within a physical environment,
a camera attached to the object at least a two-way axis gyroscopic stabilizer, and
a computational-communication module comprising:
a transceiver communicatively coupled through at least one of a wireless connection and a wired connection to a computing device storing a marker base within a database, and
a set of computer readable instructions stored in a memory of the computational-communication module that when executed on a processor of the computational-communication module causes the processor to:
capture with the camera attached to the object an image comprising one or more markers each having a graphic identifier;
at least one of normalize and filter the image to increase a recognition capability;
search the marker base stored in the database;
recognize the one or more markers within the marker base to result in one or more recognized markers;
evaluate a quality metric of each of the one or more recognized markers;
select based on the quality metric one or more best markers that are a subset of the one or more recognized markers;
calculate a physical coordinate of the object based on the one or more best markers;
filter the physical coordinate of the object through a Kalman filter capable of self-tuning to result in a filtered physical coordinate; and
transmit the filtered physical coordinate of the object to the computing device.

32. The system of claim 31, wherein the one or more recognized markers within the marker base are each associated with a coordinate data specifying a physical coordinate of each of the one or more recognized markers.

33. The system of claim 32, wherein the set of computer readable instructions stored in the memory of the computational-communication module, when executed on a processor of the computational-communication module, further causes the processor to:
determine that one of the one or more recognized markers is unassociated with an instance of the physical coordinate within the marker base to determine an unassociated marker;
calculating a physical coordinate of the unassociated marker and generating a coordinate data of the unassociated marker; and
expanding the virtual environment by storing the physical coordinate of the unassociated marker in association with the unassociated marker in the marker base to result in a new associated marker.

34. The system of claim 33, wherein the set of computer readable instructions stored in the memory of the computational-communication module, when executed on a processor of the computational-communication module, further causes the processor to:
at least one of superimpose a black-and-white filter on the image, adapt a resolution of the image, and adapt a contrast of the image.

35. The method of claim 34, further comprising:
wherein one or more instances of the marker are attached to a planar surface,
wherein the physical coordinate of the unassociated marker is determined based on one or more associated markers within view of the camera,
wherein the quality metric is at least one of: (i) a largest area of a marker within the image, (ii) a high confidence coefficient obtained through a marker recognition library, (iii) a high illuminance, and (iv) a best arrangement in the image,
wherein the camera is installed on the object with a gyroscopic stabilizer vertically to capture a horizontal plane to which the one or more markers are associated,
wherein the horizontal plane is a ceiling of a room,

36. The method of claim 34, further comprising:
wherein the camera is installed on the object with a gyroscopic stabilizer horizontally to capture a horizontal plane to which the one or more markers are associated,
wherein the vertical plane is a wall of a room,
wherein the object is at least one of a human, a drone, and a robot, and
wherein recognition occurs through a recognition library that is at least one of: ArToolKit, ARTag, ARUco, OpenCV, and VisionWorks.

37. The method of claim 36, further comprising:
an external computing device as an instance of the computing device, the external computing device comprising a processor of the external computing device and a memory of the external computing device, the memory of the external computing device comprising computer readable instructions that when executed on the processor of the external computing device:
receives the filtered physical coordinate, and
references the marker base within the database, wherein the database is stored on the external computing device.

38. A computer readable memory comprising stored instructions that when executed on a processor comprise the operations of:
capturing with a camera attached to the object an image comprising one or more markers each having a graphic identifier;
at least one of normalizing and filtering the image to increase a recognition capability;
searching a marker base stored in a database;
recognizing the one or more markers within the marker base to result in one or more recognized markers;
evaluating a quality metric of each of the one or more recognized markers;
selecting based on the quality metric one or more best markers that are a subset of the one or more recognized markers;
calculating a physical coordinate of the object based on the one or more best markers;
filtering the physical coordinate of the object through a Kalman filter capable of self-tuning to result in a filtered physical coordinate; and
transmitting the filtered physical coordinate of the object to a computing device.

39. The computer readable memory of claim 38, further comprising stored instructions that when executed on a processor comprise the operations of:
determining that one of the one or more recognized markers is unassociated with an instance of the physical coordinate within the marker base to determine an unassociated marker;
calculating a physical coordinate of the unassociated marker and generating a coordinate data of the unassociated marker;
expanding the virtual environment by storing the physical coordinate of the unassociated marker in association with the unassociated marker in the marker base to result in a new associated marker; and
at least one of superimposing a black-and-white filter on the image, adapting a resolution of the image, and adapting a contrast of the image.

40. The computer readable memory of claim 39, wherein:
wherein one or more instances of the marker are attached to a planar surface,
wherein the physical coordinate of the unassociated marker is determined based on one or more associated markers within view of the camera,
wherein the quality metric is at least one of: (i) a largest area of a marker within the image, (ii) a high confidence coefficient obtained through a marker recognition library, (iii) a high illuminance, and (iv) a best arrangement in the image,
wherein the camera is installed on the object with a gyroscopic stabilizer vertically, the gyroscopic stabilizer stabilizing along at least two axes, to capture a horizontal plane to which the one or more markers are associated,
wherein the horizontal plane is a ceiling of a room, and
wherein the object is at least one of a human, a drone, and a robot.
